(19) United States
(12) Patent Application Publication
(10) Pub. No.: US 2011/0260927 A1
(43) Pub. Date: Oct. 27, 2011

(54) MOBILE COMMUNICATION DEVICE

(75) Inventors: Kin Lu WONG, Kaohsiung City (TW); Yu Wei Chang, Waipu Township (TW); Chun Yih Wu, Taipei City (TW); Wei Yu Li, Yilan City (TW)

(73) Assignees: NATIONAL SUN YAT-SEN UNIVERSITY, Kaohsiung (TW); INDUSTRIAL TECHNOLOGY RESEARCH INSTITUTE, Hsinchu (TW)

(21) Appl. No.: 12/968,863

(22) Filed: Dec. 15, 2010

(30) Foreign Application Priority Data
Apr. 27, 2010 (TW) 099113215

(51) Int. Cl. H01Q 1/38

(52) U.S. Cl. 343/700 MS

(57) ABSTRACT

A mobile communication device comprises a dielectric substrate and an antenna. The dielectric substrate has a ground region, a first no-ground region and a second no-ground region. The ground region comprises a primary ground plane and a protruded ground plane. The protruded ground plane is electrically connected to the primary ground plane and extends between the first no-ground region and the second no-ground region, such that the protruded ground plane separates the first no-ground region from the second no-ground region. The antenna comprises a first radiating portion and a second radiating portion. The first radiating portion is disposed in the first no-ground region. The start terminal of the second radiating portion is disposed in the second no-ground region. The second radiating portion extends and crosses over the protruded ground plane such that the end terminal of the second radiating portion is disposed in the first no-ground region.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The disclosure is related to a mobile communication device, and in particular, to a mobile communication device embedded with an antenna which is capable of wideband and/or multiband operation.

2. Description of Related Art Including Information Disclosed Under 37 CFR 1.97 and 37 CFR 1.98

With the development of wireless communication technology, the functions of mobile communication devices increase rapidly, and therefore how to design a small-size or thin-type mobile communication device capable of multi-function operation has become an important design target.

In order to achieve compact and thin-type antenna designs capable of wideband and/or multiband operation in a mobile communication device, a known technique is to directly dispose the antenna element in a no-ground region of the system circuit board of a mobile communication device to reduce the Q factor of the antenna, such that wider impedance bandwidths of resonant modes of the antenna could be achieved to cover many operating bands of WWAN systems, such as GSM850, GSM900, GSM1800, GSM1900 or UMTS systems. However, most of such WWAN antennas are disposed in a single no-ground region, and are disposed at the top or bottom positions of a mobile communication device. For example, R.O.C. patent publication No. 200950209, titled “A MOBILE COMMUNICATION DEVICE ANTENNA,” discloses a mobile communication device antenna designed in a single no-ground region of a mobile phone to achieve wideband and/or multiband operation for WWAN systems. Nevertheless, for such antenna designs, since there does not exist a system ground between the antenna and a user's head, the antenna would generally need to be disposed at the bottom position of the mobile phone to obtain a smaller specific absorption rate (SAR) of user's heads for meeting SAR standards. But when the antenna is disposed at the bottom position of a mobile phone, it would be difficult to integrate the antenna with other nearby energy transmission components, such as a universal serial bus (USB) connector, a speaker component, a camera lens, an antenna component or an integrated circuit chip (IC), which would be often disposed at the bottom position of a mobile phone. It is because that the metal material of these energy transmission components would reduce the impedance bandwidth of the antenna, and also degrade the radiation efficiencies of the antenna. Accordingly, it would be more difficult to optimize the use of interior space of a mobile communication device and to arrange the interior components of a mobile communication device compactly.

### BRIEF SUMMARY OF THE INVENTION

This disclosure provides a mobile communication device, which could be embedded with a WWAN antenna integrated with a ground plane able to accommodate an energy transmission component to enhance the design flexibility of the arrangement of the interior devices of a mobile communication device.

An embodiment discloses a mobile communication device, comprising a dielectric substrate and an antenna. The dielectric substrate has a ground region, a first no-ground region and a second no-ground region. The ground region comprises a primary ground plane and a protruded ground plane. The protruded ground plane is electrically connected to the primary ground plane and extends between the first no-ground region and the second no-ground region such that the first no-ground region is separated from the second no-ground region. The antenna comprises a first radiating portion and a second radiating portion. The first radiating portion is disposed in the first no-ground region. The start terminal of the second radiating portion is disposed in the second no-ground region. The second radiating portion extends and crosses over the protruded ground plane such that the end terminal of the second radiating portion is disposed in the first no-ground region.

Another embodiment discloses a mobile communication device, comprising a dielectric substrate and an antenna. The dielectric substrate has a ground region, a first no-ground region and a second no-ground region. The ground region comprises a primary ground plane and a protruded ground plane. The protruded ground plane is electrically connected to the primary ground plane and extends between the first no-ground region and the second no-ground region such that the first no-ground region is separated from the second no-ground region. The antenna comprises a first radiating portion and a second radiating portion. The first radiating portion is disposed in the first no-ground region. The second radiating portion is disposed in the second no-ground region.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the invention.

FIG. 1 shows a schematic view of an exemplary embodiment of this disclosure, the mobile communication device 1;

FIG. 2 shows a diagram of measured return loss of the mobile communication device in accordance with the exemplary embodiment of this disclosure shown in FIG. 1;

FIG. 3 shows a schematic view of an exemplary embodiment of this disclosure, the mobile communication device 3;

FIG. 4 shows a schematic view of an exemplary embodiment of this disclosure, the mobile communication device 4; and

FIG. 5 shows a schematic view of an exemplary embodiment of this disclosure, the mobile communication device 5.

### DETAILED DESCRIPTION OF THE INVENTION

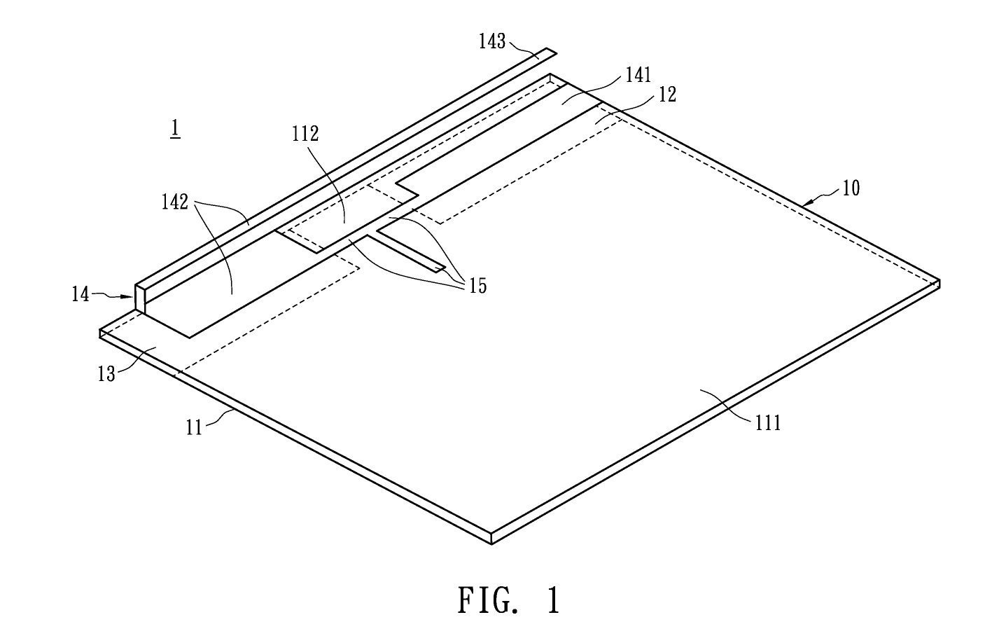

FIG. 1 shows a schematic view of an exemplary embodiment of this disclosure, the mobile communication device 1. The mobile communication device 1 comprises a dielectric substrate 10 and an antenna 14. The dielectric substrate 10 has a ground region 11, a first no-ground region 12 and a second no-ground region 13. The ground region 11 comprises a primary ground plane 111 and a protruded ground plane 112. The protruded ground plane 112 is electrically connected to the primary ground plane 111 and extends between the first no-ground region 12 and the second no-ground region 13 such that the first no-ground region 12 is separated from the second no-ground region 13. The protruded ground plane 112 has an edge aligned with an edge of the dielectric substrate 10. The antenna 14 comprises a first radiating portion 141 and a second radiating portion 142, and has signal feeding lines 15 disposed in the region of the protruded ground plane 112. The first radiating portion 141 is disposed in the first no-ground region 12. The start terminal of the second radiating portion 142 is disposed in the second no-ground region 13 and the second radiating portion 142 extends and crosses over the protruded ground plane 112 such that the end terminal 143 of the second radiating portion 142 is disposed in the first no-ground region 12. It should be noted that the term “disposed in the region” comprises the cases of located on the surface of the region and located in the space above the region.

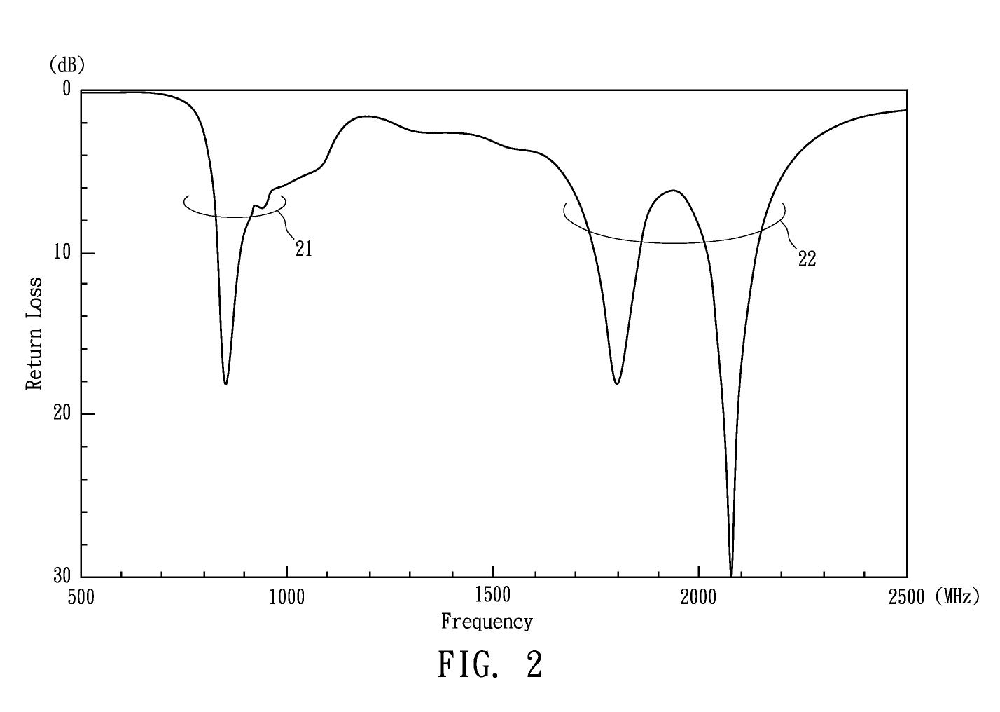

FIG. 2 shows a diagram of measured return loss of the mobile communication device in accordance with the exemplary embodiment of this disclosure shown in FIG. 1, wherein the horizontal axis represents frequencies, and the vertical axis represents return loss. In this exemplary embodiment, dimensions of components of the mobile communication device 1 are as follows: The length of the dielectric substrate 10 is about 110 mm. The width of the dielectric substrate 10 is about 60 mm. The thickness of the dielectric substrate 10 is about 0.8 mm. The length of the primary ground plane 111 is about 100 mm. The width of the primary ground plane 111 is about 60 mm. The length of the protruded ground plane 112 is about 10 mm. The width of the protruded ground plane 112 is about 10 mm. The length of the first no-ground region 12 is about 10 mm. The width of the first no-ground region 12 is about 25 mm. The length of the second no-ground region 13 is about 10 mm. The width of the second no-ground region 13 is about 25 mm. From the experimental results, based on the 6 dB return loss definition acceptable for practical application, the first operating band 21 could cover GSM850, GSM900 bands (824 to 960 MHz), and the second operating bands 22 could cover GSM1800, GSM1900 and UMTS bands (1710 to 2170 MHz). Accordingly, the antenna 14 of the mobile communication device 1 could achieve the penta-band operation for WWAN systems.

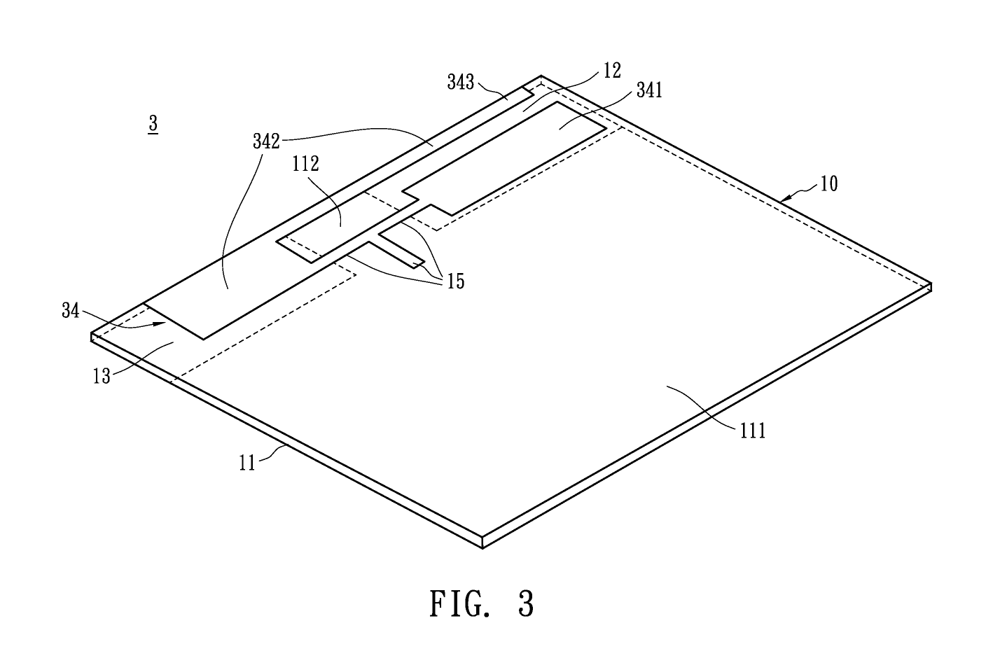

FIG. 3 shows a schematic view of an exemplary embodiment of this disclosure, the mobile communication device 3. The mobile communication device 3 comprises a dielectric substrate 10 and an antenna 34. The dielectric substrate 10 has a ground region 11, a first no-ground region 12 and a second no-ground region 13. The ground region 11 comprises a primary ground plane 111 and a protruded ground plane 112. The protruded ground plane 112 is electrically connected to the primary ground plane 111 and extends between the first no-ground region 12 and the second no-ground region 13 such that the first no-ground region 12 is separated from the second no-ground region 13. The protruded ground plane 112 has an edge aligned with an edge of the dielectric substrate 10. The antenna 34 comprises a first radiating portion 341 and a second radiating portion 342, and has signal feed lines 15 disposed in the region of the protruded ground plane 112. The first radiating portion 341 is disposed in the first no-ground region 12. The start terminal of the second radiating portion 342 is disposed in the second no-ground region 13 and the second radiating portion 342 extends and crosses over the protruded ground plane 112 such that the end terminal 343 of the second radiating portion 342 is disposed in the first no-ground region 12. It should be noted that the term “disposed in the region” comprises the cases of located on the surface of the region and located in the space above the region. The major difference between the mobile communication device 1 and the mobile communication device 3 is that both the first radiating portion 341 and the second radiating portion 342 of the mobile communication device 3 are planar structures, such that the thickness of the antenna 34 on the dielectric substrate 10 is reduced. The antenna 34 could also be formed on the surface of the dielectric substrate 10 by printing or etching techniques. However, the antenna mechanism of the mobile communication device 3 is similar to that of the mobile communication device 1 shown in FIG. 1. Therefore, the mobile communication device 3 could also achieve an antenna performance similar to that of the mobile communication device 1.

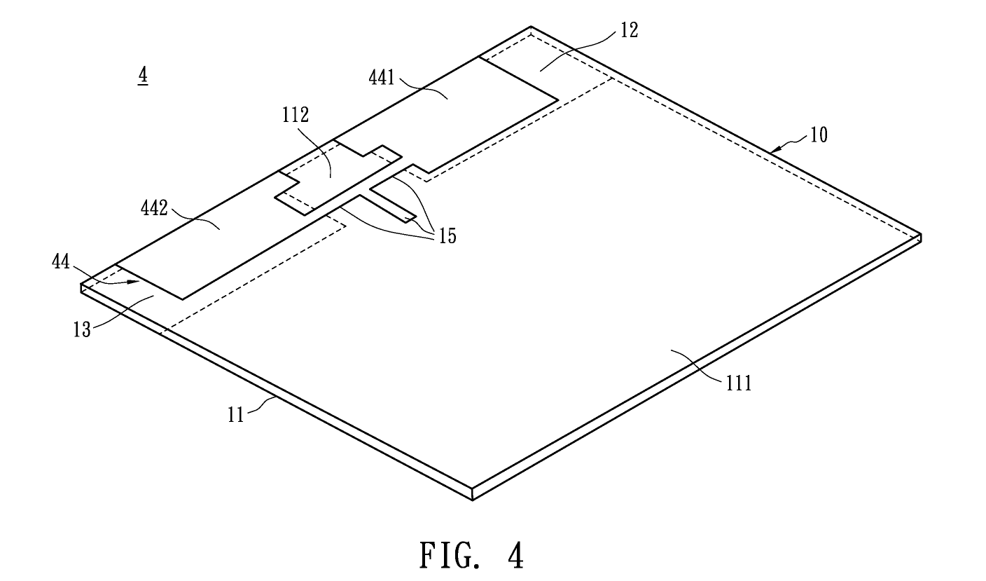

FIG. 4 shows a schematic view of an exemplary embodiment of this disclosure, the mobile communication device 4. The mobile communication device 4 comprises a dielectric substrate 10 and an antenna 44. The dielectric substrate 10 has a ground region 11, a first no-ground region 12 and a second no-ground region 13. The ground region 11 comprises a primary ground plane 111 and a protruded ground plane 112. The protruded ground plane 112 is electrically connected to the primary ground plane 111 and extends between the first no-ground region 12 and the second no-ground region 13 such that the first no-ground region 12 is separated from the second no-ground region 13. The protruded ground plane 112 has an edge aligned with an edge of the dielectric substrate 10. The antenna 44 comprises a first radiating portion 441 and a second radiating portion 442, and has signal feed lines 15 located in the region of the protruded ground plane 112. The first radiating portion 441 is disposed in the first no-ground region 12. The second radiating portion 442 is disposed in the second no-ground region 13. The major difference between the mobile communication device 1 and the mobile communication device 4 is that the second no-ground region 13 of the mobile communication device 4 has a sufficient area for the second radiating portion 442 to be disposed in it. Similarly, the first radiating portion 441 is also disposed in the first no-ground region 12. It should be noted that the term “disposed in the region” comprises the cases of located on the surface of the region and located in the space above the region. The antenna 44 could also be formed on the dielectric substrate 10 by printing or etching techniques. The antenna mechanism of the mobile communication device 4 is similar to that of the mobile communication device 1 shown in FIG. 1. Therefore, the mobile communication device 4 could also achieve an antenna performance similar to that of the mobile communication device 1.

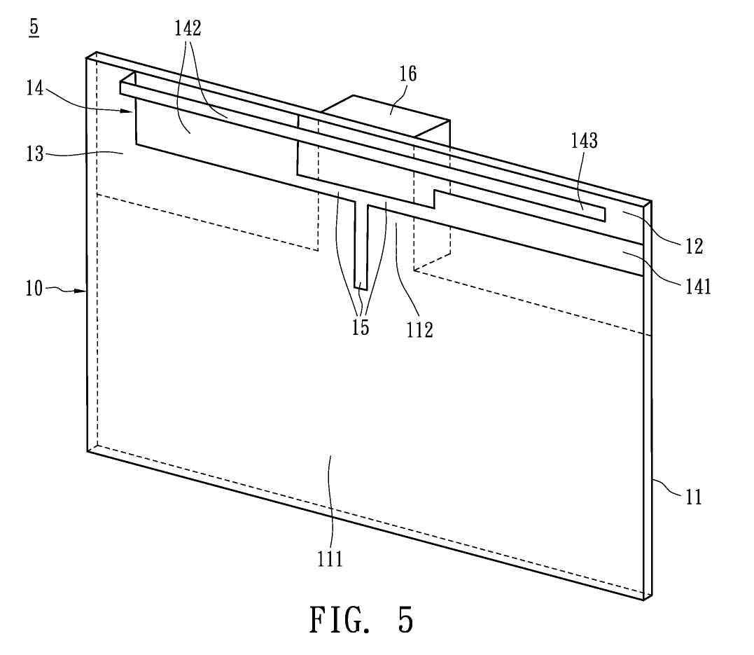

FIG. 5 shows the schematic view of an exemplary embodiment of this disclosure, the mobile communication device 5. As shown in FIG. 5, an energy transmission component 16 (e.g., a USB connector, a speaker device, a camera lens, an antenna device or an integrated circuit chip) is disposed on the protruded ground plane 112 of the mobile communication device 1. The energy transmission device 16 could increase the data transmission functions of the mobile communication device 5. Other mobile communication devices provided by this disclosure could also achieve the similar functions compared with the mobile communication device 5. In addition, all of the mobile communication devices provided by this disclosure could be applied to be a mobile phone, and the dielectric substrate 10 of these mobile communication devices could be a system circuit board of the mobile phone. Therefore, all of the antennas 14, 34 and 44 could be disposed at the bottom position of a mobile phone and integrated with the energy transmission component 16.

In conclusion, due to the fact that the mobile communication devices in accordance with the exemplary embodiments of this disclosure are all embedded with an antenna comprising two radiating portions disposed in two separated no-ground regions respectively, a lower Q factor of the antenna could be achieved to satisfy the requirement of wideband or multiband operations (e.g. 824 to 960 MHz and 1710 to 2170 MHz) for WWAN systems. In addition, by configuring the protruded ground plane in accordance with the exemplary embodiments of this disclosure to be located between the two separated no-ground regions, energy transmission components could be disposed on the protruded ground plane to increase the data transmission functions of the mobile communication devices. Therefore, the antennas in accordance with the exemplary embodiments of this disclosure are suitable for wideband or multiband operations for WWAN systems, and could also be integrated with the energy transmission components disposed at the bottom position of a mobile communication device compactly, such that the design flexibility of the arrangement of the interior devices of the mobile communication device could be enhanced.

The above-described exemplary embodiments are intended to be illustrative only. Those skilled in the art may devise numerous alternative embodiments without departing from the scope of the following claims.

We claim:

1. A mobile communication device, comprising:
a dielectric substrate, having a ground region, a first no-ground region and a second no-ground region, the ground region comprising a primary ground plane and a protruded ground plane, the protruded ground plane electrically connected to the primary ground plane and extending between the first no-ground region and the second no-ground region such that the first no-ground region is separated from the second no-ground region; and
an antenna, comprising a first radiating portion and a second radiating portion, the first radiating portion disposed in the first no-ground region, the start terminal of the second radiating portion disposed in the second no-ground region, the second radiating portion extending and crossing over the protruded ground plane such that the end terminal of the second radiating portion is disposed in the first no-ground region.

2. The mobile communication device of claim 1, wherein the dielectric substrate is a system circuit board of a mobile phone.

3. The mobile communication device of claim 1, wherein the protruded ground plane is able to accommodate components having metal material.

4. The mobile communication device of claim 1, wherein the protruded ground plane has an edge aligned with an edge of the dielectric substrate.

5. The mobile communication device of claim 1, wherein the protruded ground plane is able to accommodate an energy transmission component to increase data transmission functions of the mobile communication device.

6. The mobile communication device of claim 5, wherein the energy transmission component is a universal serial bus connector, a speaker component, a camera lens, an antenna component or an integrated circuit chip.

7. The mobile communication device of claim 1, wherein the antenna has signal feeding lines disposed in the region of the protruded ground plane.

8. The mobile communication device of claim 1, wherein the first radiating portion is a three-dimensional structure.

9. The mobile communication device of claim 1, wherein the second radiating portion is a three-dimensional structure.

10. The mobile communication device of claim 1, wherein the first radiating portion is a planar structure, and is formed on a surface of the dielectric substrate by printing or etching techniques.

11. The mobile communication device of claim 1, wherein the second radiating portion is a planar structure, and is formed on a surface of the dielectric substrate by printing or etching techniques.

12. The mobile communication device of claim 1, wherein the antenna has a first operating band and a second operating band for wireless wide area network (WWAN) operation.

13. A mobile communication device, comprising:
a dielectric substrate, having a ground region, a first no-ground region and a second no-ground region, the ground region comprising a primary ground plane and a protruded ground plane, the protruded ground plane electrically connected to the primary ground plane and extending between the first no-ground region and the second no-ground region such that the first no-ground region is separated from the second no-ground region; and
an antenna, comprising a first radiating portion and a second radiating portion, the first radiating portion disposed in the first no-ground region, the second radiating portion disposed in the second no-ground region.

14. The mobile communication device of claim 13, wherein the dielectric substrate is a system circuit board of a mobile phone.

15. The mobile communication device of claim 13, wherein the protruded ground plane has an edge aligned with an edge of the dielectric substrate.

16. The mobile communication device of claim 13, wherein the protruded ground plane is able to accommodate components having metal material.

17. The mobile communication device of claim 13, wherein the protruded ground plane is able to accommodate an energy transmission component to increase data transmission functions of the mobile communication device.

18. The mobile communication device of claim 17, wherein the energy transmission component is a universal serial bus connector, a speaker device, a camera lens, an antenna component or an integrated circuit chip.

19. The mobile communication device of claim 13, wherein the first radiating portion is a three-dimensional structure.

20. The mobile communication device of claim 13, wherein the second radiating portion is a three-dimensional structure.

21. The mobile communication device of claim 13, wherein the first radiating portion is a planar structure, and is formed on a surface of the dielectric substrate by printing or etching techniques.

22. The mobile communication device of claim 13, wherein the second radiating portion is a planar structure, and is formed on a surface of the dielectric substrate by printing or etching techniques.

23. The mobile communication device of claim 13, wherein the antenna has signal feeding lines disposed in the region of the protruded ground plane.

24. The mobile communication device of claim 13, wherein the antenna has a first operating band and a second operating band for wireless wide area network (WWAN) operation.
